(19) United States
(12) Patent Application Publication
(10) Pub. No.: US 2026/0030811 A1
(43) Pub. Date: Jan. 29, 2026

(54) IMAGE PROCESSING METHOD AND RELATED DEVICE

(71) Applicant: Beijing Zitiao Network Technology Co., Ltd., Beijing (CN)

(72) Inventors: Ziyang HUANG, Beijing (CN); Jie FAN, Beijing (CN); Lifang YU, Beijing (CN); Danying LIU, Beijing (CN)

(21) Appl. No.: 19/276,782

(22) Filed: Jul. 22, 2025

(30) Foreign Application Priority Data
Jul. 24, 2024 (CN) 202411001245.6

(51) Int. Cl. G06T 11/60; G06F 3/04845; G06T 11/00

(52) U.S. Cl. CPC G06T 11/60; G06F 3/04845; G06T 11/001; G06T 2200/24; G06T 2210/62

(57) ABSTRACT

The present disclosure provides an image processing method and a related device. The method includes: displaying a background image in a first area of a first interface; in response to an import operation for a first image, displaying the first image in the background image; in response to a first matting operation, performing first matting processing on the first image to obtain a first matted image; in response to a first stylizing operation, performing first stylizing processing on the first matted image to obtain a first stylized image; and/or in response to a second stylizing processing operation, performing second stylizing processing on the at least part of the background image to obtain a second stylized image; and displaying the first stylized image or the first matted image in the first area, and displaying the background image or the second stylized image in the first area.

### CROSS-REFERENCE TO RELATED APPLICATION(S)

This application claims priority to Chinese Application No. 202411001245.6 filed on Jul. 24, 2024, the disclosure of which is incorporated herein by reference in its entirety.

### FIELD

The present disclosure relates to the field of image processing technologies, and in particular, to an image processing method and a related device.

### BACKGROUND

In image processing, various image effects are often realized by importing an image material. However, in the existing ways, it is not possible to utilize only part of a current import material, or to utilize only part of a processed material after effect processing is performed on the import material.

### SUMMARY

The present disclosure proposes an image processing method and a related device, to solve to some extent the technical problems of complex operations, low efficiency and low flexibility of image processing.

According to a first aspect of the present disclosure, an image processing method is provided. The method includes: displaying a background image in a first area of a first interface; in response to an import operation for a first image, displaying the first image in the background image; in response to a first matting operation for the first image, performing first matting processing on the first image to obtain a first matted image of the first image; in response to a first stylizing operation for the first matted image, performing first stylizing processing on the first matted image to obtain a first stylized image; and/or in response to a second stylizing processing operation for at least part of the background image, performing second stylizing processing on the at least part of the background image to obtain a second stylized image; and displaying the first stylized image or the first matted image in the first area, and displaying the background image or the second stylized image in the first area.

According to a second aspect of the present disclosure, an image processing apparatus is provided. The apparatus includes: a display module, configured to display a background image in a first area of a first interface; an import module, configured to in response to an import operation for an import image, display the import image in the background image; a matting module, configured to in response to a first matting operation for the import image, perform first matting processing on the import image to obtain a first matted image of the import image; and a stylizing module, configured to in response to a first stylizing operation for the first matted image, perform first stylizing processing on the first matted image to obtain a first stylized image; and/or in response to a second stylizing processing operation for at least part of the background image, perform second stylizing processing on the at least part of the background image to obtain a second stylized image, where the display module is further configured to display the first stylized image or the first matted image in the first area, and display the background image or the second stylized image in the first area.

According to a third aspect of the present disclosure, an electronic device is provided. The electronic device includes one or more processors and a memory; and one or more programs, where the one or more programs are stored in the memory and executed by the one or more processors, and include instructions used to perform the method according to the first aspect.

According to a fourth aspect of the present disclosure, a non-volatile computer-readable storage medium including a computer program is provided. The computer program, when executed by one or more processors, causes the one or more processors to perform the method according to the first aspect.

According to a fifth aspect of the present disclosure, a computer program product is provided, and the computer program product includes computer program instructions. The computer program instructions, when executed by a computer, cause the computer to perform the method according to the first aspect.

### BRIEF DESCRIPTION OF THE DRAWINGS

In order to more clearly describe the technical solutions in the present disclosure or in the related art, the accompanying drawings for describing the embodiments or the related art will be briefly described below. Apparently, the accompanying drawings in the description below show merely the embodiments of the present disclosure, and those of ordinary skill in the art may still derive other accompanying drawings from these accompanying drawings without creative efforts.

FIG. 1 is a schematic diagram of a structure of an image processing architecture according to an embodiment of the present disclosure;

FIG. 2 is a schematic diagram of a hardware structure of an exemplary electronic device according to an embodiment of the present disclosure.

FIG. 3 is a schematic flowchart of an image processing method according to an embodiment of the present disclosure;

FIG. 4 is a schematic diagram of a first interface according to an embodiment of the present disclosure;

FIG. 5 is a schematic diagram of a first matting panel according to an embodiment of the present disclosure;

FIG. 6 is a schematic diagram of a first matted image according to an embodiment of the present disclosure;

FIG. 7 and FIG. 8 are schematic diagrams of the principle of an effect template according to an embodiment of the present disclosure;

FIG. 9 is a schematic diagram of a second interface according to an embodiment of the present disclosure;

FIG. 10 is a schematic diagram of a preset function panel according to an embodiment of the present disclosure;

FIG. 11 is a schematic diagram of a second interface according to an embodiment of the present disclosure; and

FIG. 12 is a schematic diagram of an image processing apparatus according to an embodiment of the present disclosure.

### DETAILED DESCRIPTION OF EMBODIMENTS

In order to make the objects, technical solutions, and advantages of the present disclosure clearer, the present disclosure is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include” or “comprise” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

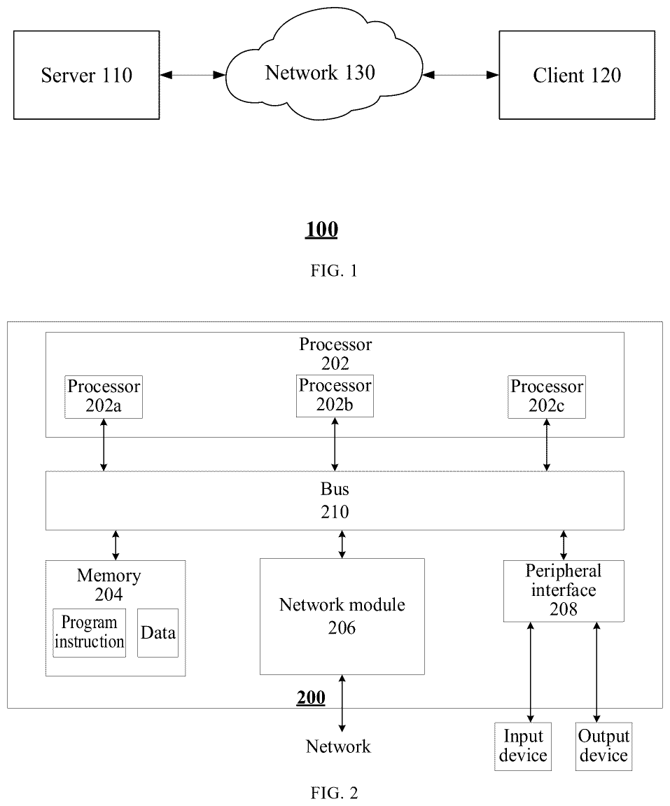

FIG. 1 shows a schematic diagram of a structure of an image processing architecture according to an embodiment of the present disclosure. Referring to FIG. 1, the image processing architecture 100 may include a server 110, a terminal 120, and a network 130 providing a communication link. The server 110 and the terminal 120 may be connected via a wired or wireless network 130. The server 110 may be a stand-alone physical server, or a server cluster or a distributed system consisting of a plurality of physical servers, or a cloud server that provides basic cloud computing services, such as cloud services, cloud databases, cloud computing, cloud functions, cloud storage, network services, cloud communication, middleware services, security services, and CDN.

The terminal 120 may be implemented in hardware or software. For example, when the terminal 120 is implemented in hardware, the terminal may be various electronic devices having a display screen and supporting interface display, including, but not limited to, a smart phone, a tablet computer, an e-book reader, a laptop portable computer and a desktop computer, etc. When the terminal 120 is implemented in software, the terminal may be installed on the electronic devices listed above. The terminal may be implemented as a plurality of pieces of software or software modules (such as a plurality of pieces of software or software modules configured to provide distributed services), or may be implemented as a single piece of software or software module. Specific limitations are not provided here.

It should be noted that the image processing method provided in embodiments of the present application may be executed by the terminal 120 or by the server 110. It should be understood that the number of the terminal, the network and the server in FIG. 1 is merely illustrative, and is not intended to be limiting. According to implementation needs, there may be any number of terminals, networks, and servers.

FIG. 2 shows a schematic diagram of a hardware structure of an exemplary electronic device 200 according to an embodiment of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are communicatively connected to each other within the electronic device 200 through the bus 210.

The processor 202 may be a central processing unit (CPU), an image processor, a neural processing unit (NPU), a microcontroller unit (MCU), a programmable logic device, a digital signal processor (DSP), an application specific integrated circuit (ASIC), or one or more integrated circuits. The processor 202 may be configured to perform functions related to the technology described in the present disclosure. In some embodiments, the processor 202 may further include a plurality of processors integrated into a single logical component. For example, as shown in FIG. 2, the processor 202 may include a plurality of processors 202a, 202b, and 202c.

The memory 204 may be configured to store data (e.g., instructions and computer code). As shown in FIG. 2, the data stored in the memory 204 may include program instructions (e.g., program instructions for implementing an image processing method in the embodiments of the present disclosure) and data to be processed (e.g., the memory may store configuration files for other modules). The processor 202 may also access the program instructions and the data stored in the memory 204 and execute the program instructions to operate the data to be processed. The memory 204 may include a volatile storage apparatus or a non-volatile storage apparatus. In some embodiments, the memory 204 may include a random access memory (RAM), a read-only memory (ROM), an optical disk, a magnetic disk, a hard drive, a solid state drive (SSD), a flash memory, a memory stick, or the like.

The network module 206 may be configured to provide communication between the electronic device 200 and other external devices via a network. The network may be any wired or wireless network capable of transmitting and receiving data. For example, the network may be a wired network, a local wireless network (e.g., Bluetooth, WiFi, and near field communication (NFC)), a cellular network, the Internet, or a combination of the above. It should be understood that the type of network is not limited to the above specific examples. In some embodiments, a network module 306 may include any combination of any number of network interface controllers (NICs), radio frequency modules, transceivers, modems, routers, gateways, adapters, cellular network chips, etc.

The peripheral interface 208 may be configured to connect the electronic device 200 with one or more peripheral apparatuses to achieve information input and output. For example, the peripheral apparatus may include an input device such as a keyboard, a mouse, a touchpad, a touchscreen, a microphone, and various sensors, and an output device such as a display, a speaker, a vibrator, and an indicator light.

The bus 210 may be configured to transmit information between various components of the electronic device 200 (e.g., the processor 202, the memory 204, the network module 206, and the peripheral interface 208), such as an internal bus (e.g., a processor-memory bus) and an external bus (a USB port and a PCI-E bus) or the like.

It should be noted that although only the processor 202, the memory 204, the network module 206, the peripheral interface 208, and the bus 210 are shown in the architecture of the above electronic device 200, during a specific implementation, the architecture of the electronic device 200 may further include other components necessary for normal execution. In addition, those skilled in the art should understand that the architecture of the above electronic device 200 may include only components necessary for implementing the solutions of the embodiments of the present disclosure, and does not necessarily include all the components shown in the figures.

In image processing, various image effects are often realized by importing an image material. However, in the existing ways, if it is desired to utilize only part of a current import material, or to utilize only part of a processed material after effect processing is performed on the import material, the material can only be processed again and then imported, which not only increases the complexity of operations, but also reduces the flexibility and efficiency of image processing. Therefore, how to improve the processing efficiency and flexibility of image processing and reduce the complexity of operations has become a technical problem that needs to be solved.

In view of this, embodiments of the present disclosure provide an image processing method and a related device. A first matting operation is performed on an imported first image, and the obtained first matted image is displayed in the background image, thereby realizing matting processing on the imported image. Compared with the prior art, according to the image processing method of an embodiment of the present disclosure, in response to an imported image not meeting an expectation of the user, the imported image can be directly adjusted by the user, thereby improving the flexibility and efficiency of image processing, and without matting and importing the image again, thus reducing the complexity of user operations.

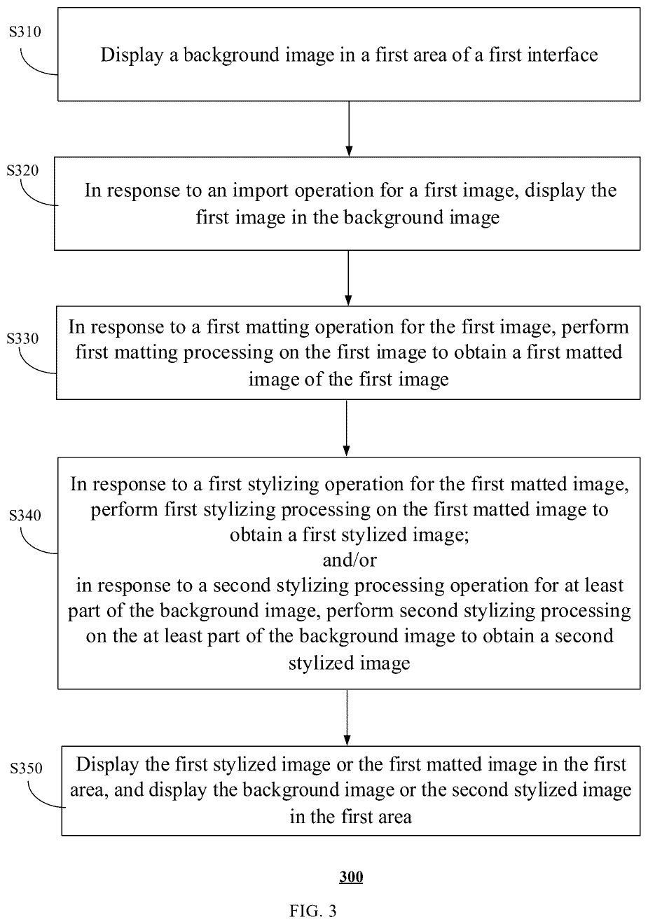

Referring to FIG. 3, FIG. 3 shows a schematic flowchart of an image processing method according to an embodiment of the present disclosure. The image processing method according to an embodiment of the present disclosure may be deployed on a terminal or server. In FIG. 3, an image processing method 300 may include the following steps.

At step S310, a background image is displayed in a first area of a first interface.

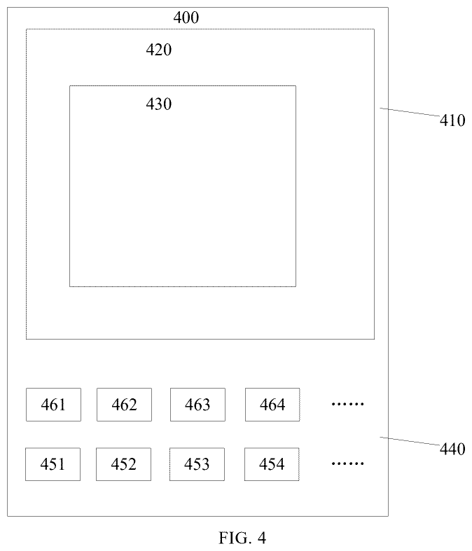

The first interface may refer to an interface for editing an image. The first area of the first interface may include at least one layer, where the layer may refer to a virtual plane for holding an image, and each of the layers may be independent of each other. For example, the background image is displayed in a background layer of the first area. FIG. 4 shows a schematic diagram of a first interface according to an embodiment of the present disclosure. In FIG. 4, a background image 420 is displayed in a first area 410 of a first interface 400. Specifically, the background image 420 may be an image imported from an image library.

At step S320, in response to an import operation for a first image, the first image is displayed in the background image.

The import operation may refer to importing the first image selected from the image library into the first area of the first interface for display. The first image may be an image on which the user expects to perform image processing with the background image. The first image may be imported directly after being selected from the image library, or may be imported after being selected from the image library and pre-processed. Pre-processing may include image processing such as matting, stylizing processing, etc. In FIG. 4, a first image 430 may be imported for display in the background image 420. A size and position of the first image 430 may be adjusted by an adjustment operation (e.g., dragging, etc.) of the first image 430.

In some embodiments, in response to the import operation for the first image, the first import image being displayed in the first area includes: displaying a first import control in a second area of the first interface; in response to an import trigger operation on the first import control, jumping to an image library interface to display an image library; and in response to a selection operation for a candidate image in the image library, displaying the first image in the first area, where the first image is obtained based on the selected candidate image.

The second area may be used to display controls related to an image effect function of the background image and/or the first image, for example, controls 451-454, . . . , and controls 461-464, . . . , in FIG. 4. In FIG. 4, a first import control 451 may be displayed in a second area 440 to import the first image 430. Specifically, the first import control 451 may be triggered by a user action (e.g., clicking), which allows the jump from the first interface to an image library interface. The image library interface includes an image library of local images, where the image library may also download images via a network (e.g., an image download control is displayed in the image library interface, and the image download control may be triggered to download images from the network for a user to choose). A user may select, from candidate images in the image library, an image to be imported into the first interface, where the image to be imported may be taken as the first image directly imported into the first area, or may be obtained by processing the selected candidate image.

In some embodiments, the first image being obtained based on the selected candidate includes:

in response to a second matting operation for the selected candidate image, performing second matting processing on the selected candidate image to obtain the first image.

Specifically, the second matting operation may refer to one or more operations of performing second matting processing on the candidate image. After selecting a candidate image in an image library by a user, the image library interface may be jumped to a second matting panel. The second matting panel may display a plurality of controls related to matting, for example, a smart matting control, a fast paintbrush control for automatically expanding a matting area based on a user-selected area, a paintbrush control for determining a matting area based on a user-selected area, an erase control for eliminating a matting area, a reset control for resetting a matting area, and a slider control for setting a parameter of the paintbrush. The user may perform a matting operation on the candidate image based on a plurality of controls in the second matting panel to obtain the first image 430 to be imported into the first area.

At step S330, in response to a first matting operation for the first image, first matting processing is performed on the first image to obtain a first matted image of the first image.

The first matting operation may refer to one or more operations of performing first matting processing on the first image. The first matting operation may include a matting operation based on a user-selected matting area, for example, a matting operation based on a quick paintbrush control or a paintbrush control. The first matting operation may also include a smart matting operation, and the smart matting operation may be implemented based on a pre-trained model for recognizing and segmenting a preset object.

In some embodiments, in response to the first matting operation for the first image, the first matting processing being performed on the first image to obtain the first matted image of the first image includes: in response to a first image being selected, displaying a first matting control in a second area of the first interface; in response to a trigger operation for the first matting control, hiding the first matting control and displaying the first matting panel; in response to a matting setting operation for the first matting panel, determining a first matting parameter; and performing, based on the first matting parameter, first matting processing on the first image to obtain a first matted image of the first image.

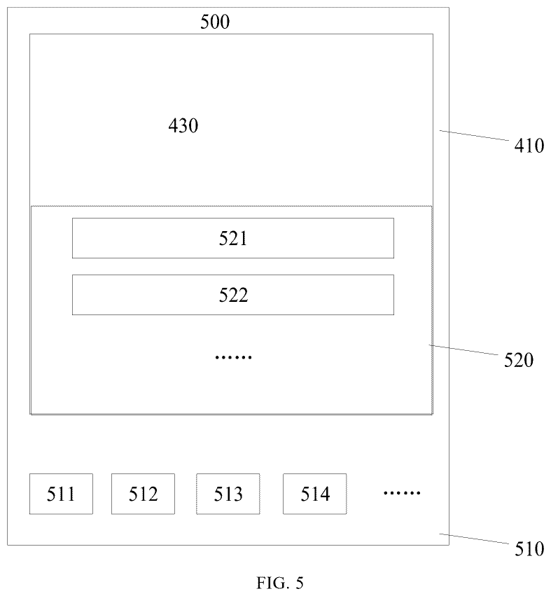

Specifically, referring to FIG. 4, a first matting control 461 is displayed in the second area 440, and once the first matting control 461 is triggered, the controls 451-454, . . . , and the controls 461-464, . . . may be hidden; and the first matting panel 500 may be displayed, as shown in FIG. 5. FIG. 5 shows a schematic diagram of a first matting panel according to an embodiment of the present disclosure. In FIG. 5, the first matting panel 500 may include a first matting control area 510 for displaying a plurality of controls 511-514, . . . related to matting, for example, a smart matting control, a quick paintbrush control, a paintbrush control, an erase control, a reset control, a preview control, an undo control, a redo control, or the like. The first matting panel 500 may also include a paintbrush parameter area 520, slider controls 521, 522 for setting a paintbrush parameter, . . . , displayed in a form of a floating layer in a portion of the first area. Only the first layer corresponding to the first image is visible in the first matting panel 500, and no other layers within a canvas are visible. Processing results of generic editing capabilities, for example, flipping, erasing, composing, playing, masking, etc., are visible in the first matting panel 500. By triggering a preview operation, the overall result of the generic capabilities and the first matting processing for an image may be displayed. An input image recognized during smart matting is the first image, without erasing and masking effects on the first layer of the first image, that is, the complete first image is used as an input image for a matting model. After it is determined in the first matting panel 500 to apply first matting processing to the first image, a first matted image is obtained. The first matted image may support secondary editing with erasing/masking. The size of the corresponding first layer selection box is the minimum bounding rectangle of the matting result, and the position of the first layer may include a first layer selection box that can be centered with blank space to adapt to the layer selection box of the first image before entering the first matting panel 500.

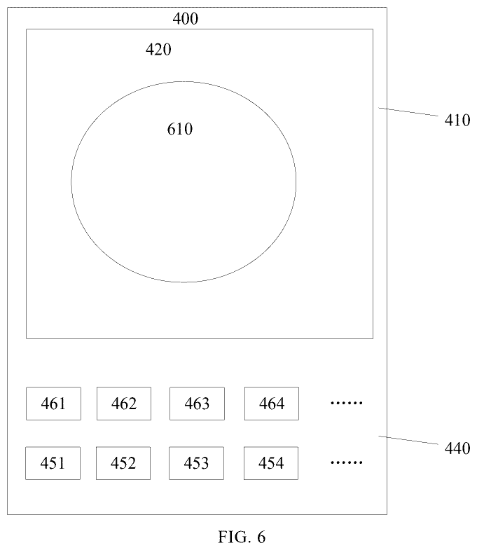

After a first matting parameter is determined on the first matting panel, a first matting area may be determined based on the first matting parameter, and first matting processing is performed, based on the first matting area, on the first image to obtain a first matted image 610. As shown in FIG. 6, FIG. 6 shows a schematic diagram of a first matted image according to an embodiment of the present disclosure.

In some embodiments, the method 300 further includes: performing, before the first matting operation, first effect processing on the first image and/or the background image to obtain a first effect image. In response to a first matting operation for the first image, the first matting processing being performed on the first image to obtain the first matted image of the first image further includes: in response to a first matting operation for the first effect image, performing first matting processing on the first effect image to obtain a matting result of the first effect image as the first matted image.

A user may perform at least one type of effect processing, for example, stylizing processing, etc., on the imported first image to obtain a corresponding first effect image. At this time, the first effect image may have some more content compared with the first image, for example, some areas or elements are added. However, some of the content is not what a user desires, and for the traditional method, the user can only delete the first effect image, select a candidate image from the image library again for performing matting and importing for the first image, and even after the re-operation, still not be able to remove undesired content from the first effect image. Although some undesired content can be removed by erasing processing, the erasing processing is operated manually, the obtained erasing effect is not good, especially the edges of the erased area are rough. However, according to the image processing method in embodiments of the present disclosure, matting processing after effect processing of the imported image can be realized, which not only allows for the quick removal of undesired content but also produces good results, contributing to an overall improvement in image processing effect.

At step S340, in response to a first stylizing operation for the first matted image, first stylizing processing is performed on the first matted image to obtain a first stylized image; and/or in response to a second stylizing processing operation for at least part of the background image, second stylizing processing is performed on the at least part of the background image to obtain a second stylized image.

The stylizing processing may refer to converting an image into a version with a specific style while maintaining original image content, so that the image presents a different style, for example, oil painting, sketch, watercolor painting, a cartoon style, or the like. Stylizing processing may be performed on the first matted image and/or at least part of the background image, respectively, to realize the effect of local stylization.

In some embodiments, the first matting operation includes a preset matting operation regarding a preset object, and the method 300 further includes: recording an actual processing order of at least one of the first stylizing processing or the second stylizing processing and the first matting operation to obtain an effect processing order for each layer; and generating an effect template based on one of the first stylized image or the first matted image and one of the second stylized image or the background image, where effect attributes of the effect template include: an effect processing order of each layer, a background layer position of the background image, and a layer position of each layer.

Specifically, in response to a preset matting operation being performed on the first image, for example, smart matting, a corresponding effect template may be generated. It can be determined whether effect processing, for example, stylizing processing, is applied to the first layer corresponding to the first image. In response to the effect processing being applied, the matting attributes and the corresponding effect processing order may be brought into the template. Before and after effect processing is applied, one process of matting may be recorded. For example, a certain layer is first applied smart matting O1, then applied stylizing processing O2 and then applied smart matting O3, the effect processing order of the layer when a template is generated is O1-O2-O3. When the template is invoked, the layer may be processed by applying O1-O2-O3 in order.

In some embodiments, the second matting operation includes the preset matting operation; and recording the actual processing order of at least one of the first stylizing processing or the second stylizing processing and the first matting operation to obtain an effect processing order for each layer further includes: recording an actual processing order of the second matting operation, the first matting operation, and the first stylizing processing and/or the second stylizing processing to obtain an effect processing order of each layer, where in response to the second matting operation and the first matting operation being consecutive operations, the second matting operation and the first matting operation are merged and recorded.

Specifically, for another example, a certain layer is first applied smart matting O4, then applied smart matting O5 by entering into the first matting panel again, and then applied stylizing processing O6; when the template is generated, the smart matting O4 and the smart matting O5 may be merged and recorded as matting O7, and the order of effect processing on the layer when the template is generated is O7-O6. When the template is invoked, the layer may be processed by applying O7-O6 in order. In this way, the processing time may be shortened by merging and recording consecutive matting operations, thereby further improving the efficiency of image processing.

In some embodiments, the method 300 further includes: in response to the effect template being invoked, processing the image to be processed based on the effect attributes.

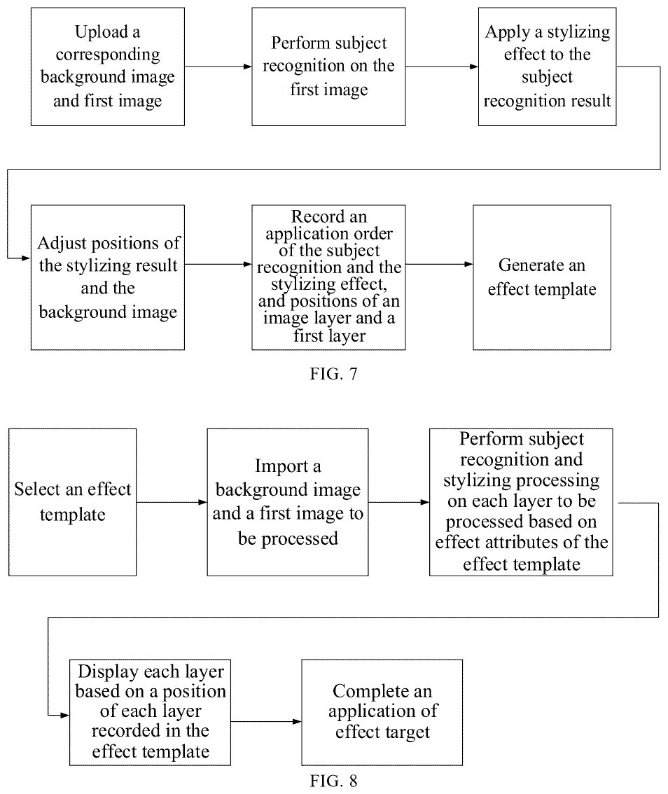

Specifically, referring to FIGS. 7 and 8, FIGS. 7 and 8 show a schematic diagram of the principle of an effect template according to an embodiment of the present disclosure. In FIGS. 7 and 8, a corresponding original image (e.g., a background image) and a target stylized image (e.g., a first image) may be uploaded, and then subject recognition (e.g., smart matting processing) is performed on the target stylized image to obtain a recognition result (e.g., a matting result); and effect processing (e.g., an image effect) is applied to the recognition result to obtain a local stylized image. The positions of the local stylized image and the original image may be adjusted, and application order of the subject recognition and the image effect and the positions of the original image layer and the stylized image layer may be recorded through an intermediate layer interface (e.g., an editing interface), and then an effect template may be generated and published. When the effect template is invoked, for the previous corresponding original image and the target stylized image, the subject recognition and image effect application may be performed by the data of the effect template via the intermediate layer interface, and the processed target stylized image and the original image is restored to the position recorded by the effect template, and a template application result may be obtained.

At step S350, the first stylized image or the first matted image is displayed in the first area, and the background image or the second stylized image is displayed in the first area.

At step S350, the first stylized image or the first matted image is displayed in the first area, and the background image or the second stylized image is displayed in the first area.

First stylizing processing may be performed on the first matted image to obtain a first stylized image. The first stylized image is displayed with the background image in a first area to achieve a local stylized effect. Second stylized processing may also be performed on at least part of the background image, for example, by directly performing second stylized processing on the background image, or performing matting processing on the background image and then performing second stylized processing, to obtain a second stylized image. The second stylized image may be displayed with the first matted image in a first area. The first matted image and the background image may also both be stylized, and the resulting first stylized image and second stylized image may be displayed in the first area.

Further, the position of the first layer corresponding to the first matted image or the first stylized image and the position of the background layer corresponding to the background image or the second stylized image may be adjusted to achieve an image processing effect desired by a user. Further, layer merging may also be performed on individual layers to form a target image for local image stylization. In some embodiments, the background image is displayed in a background layer of the first interface, and the first image and the first matted image are displayed in a first layer of the first interface; and the displaying the first matted image in the background image includes: a first layer selection box for the first layer corresponding to the first matted image including a minimum bounding rectangle for the first matted image; and/or a first layer position of the first layer corresponding to the first matted image being located in a centered position of the first image when displayed in the first layer.

For an image subjected to matting processing (e.g., a background image and/or a first image), a corresponding layer selection box may be determined as a minimum bounding rectangle of a matting result. In this way, the layer selection box subjected to the matting processing does not contain an area outside the matting result, and there is no need to set a visualization area (i.e., a visible size range of the layer, where the invisible area hides the content of the layer, and the underlying layer may be exposed) of the layer selection box, which does not form an occlusion in the display, which facilitates precise positioning and can alleviate the problem of a display position being excessively offset.

In some embodiments, the method 300 further includes: displaying a second image in a second interface, where the second image is imported into the second interface via an image library; in response to the second image being selected, displaying a second layer selection box for the second image, where a function panel control regarding a preset function is displayed at a preset position of the second layer selection box; in response to a trigger operation for the function panel control, displaying a preset function panel corresponding to the preset function; in response to a setting operation of the preset function panel, determining a function operation parameter; and performing preset function processing on the second image based on the function operation parameter to obtain an image processing result.

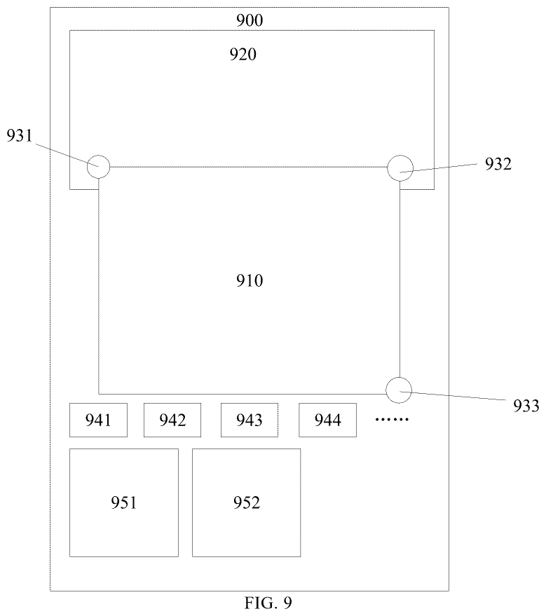

The second interface may be used as an interface for editing the second image, and the second image may be the same as or different from the first image. Referring to FIG. 9, FIG. 9 shows a schematic diagram of a second interface according to an embodiment of the present disclosure. In FIG. 9, there are second images 910 and 920 displayed in the second interface 900, and a user may select the second image 910 and then a second layer selection box for the second image 910 may be displayed. Controls 931-933 are provided at a preset position (e.g., a top corner position) of the second layer selection box, e.g., a control 931 may be a function panel control regarding a preset function, and the control 932 may be an image change control for changing an image. The preset function may be an erasing function for hiding the selected area of an image. Controls 941-944, . . . and image slots 951-952 may also be displayed in the second interface, for example, the control 941 may be an edit control for editing the selected image, the control 942 may be a filter control for making filter adjustments to the selected image, the control 943 may be a color adjustment control for adjusting the color of the selected image, and the control 944 may be a text change control for changing text of the selected image. The image slot 951 may correspond to the second image 910, and the image slot 952 may correspond to the second image 920.

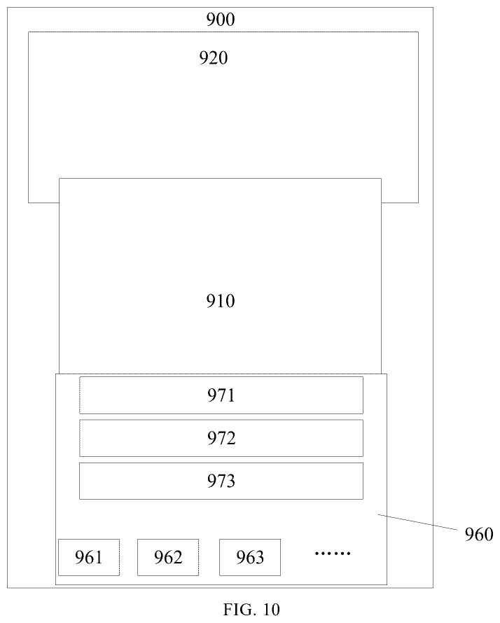

The user may trigger the function panel control 931 to display, in the second interface 900, a preset function panel (e.g., an erasing panel) corresponding to the preset function while hiding the controls 931-933, the controls 941-944, . . . , and image slots 951-952, as shown in FIG. 10. FIG. 10 shows a schematic diagram of a preset function panel according to an embodiment of the present disclosure. In FIG. 10, at least one of controls 961-963 may be displayed on the preset function panel 960 in the second interface 900, where the control may include an erasing pen control for determining an erased area, a restore pen control for removing the erased area, a reset control for resetting the second image, an undo control, a redo control, etc. When a user triggers the erase pen control or the restore pen control, the preset function panel may also display slider controls 971-973 for setting parameters of the erase pen or the restore pen, for example, hardness, transparency, size, etc. For example, a user may set a parameter of the erasing pen to determine a function operation parameter; and erasing may be performed on the second image based on the function operation parameter, to obtain an erasing result, i.e., an image processing result of the second image. It should be understood that the above erasing function is merely illustrative, and is not intended to limit the preset function, and the preset function may also be an image processing function other than erasing, which is not limited herein.

In some embodiments, the second interface further displays an image slot of the second image. The method 300 further includes: in response to a trigger operation for the image slot, displaying the second layer selection box for the second image, and displaying a first preset control in an associated area of the image slot; or in response to the second image being selected, displaying an edit identifier in the image slot corresponding to the second image, where the edit identifier is used for displaying a first preset control in an associated area of the image slot; and in response to a trigger operation for the first preset control, displaying the preset function panel.

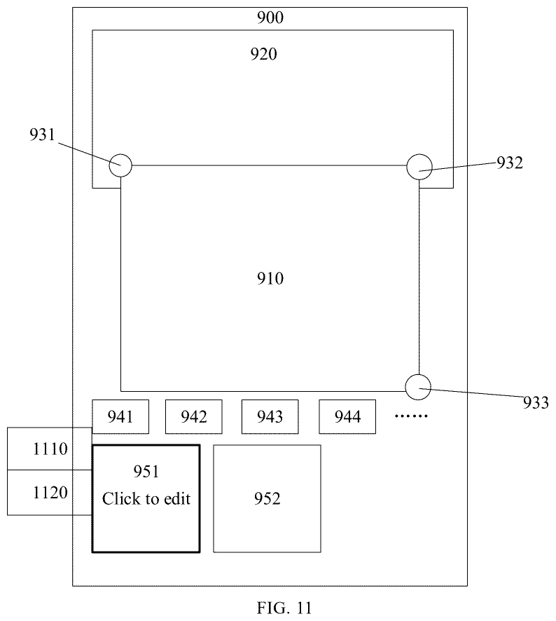

Specifically, a user may select an image slot, for example, by clicking on the image slot 951. Since the image slot 951 corresponds to the second image 910, a second layer selection box for the second image 910 is displayed when the image slot 951 is clicked, and controls 931-933 are provided at a preset position (e.g., a top corner position) on the second layer selection box, as shown in FIG. 9. At the same time, the image slot 951 also displays an editing identifier, such as “click to edit”. In this case, when a user clicks on the image slot 951, a first preset control 1110 and/or an image change control 1120 may be displayed in the form of a floating layer in an associated area of the image slot 951, as shown in FIG. 11. FIG. 11 shows a schematic diagram of a second interface according to an embodiment of the present disclosure. In FIG. 11, the first preset control 1110 is used to trigger a preset function panel 960, and the image change control 1120 is used to replace a corresponding second image 910. When a user triggers the first preset control 1110, the preset function panel corresponding to the preset function (e.g., the erasing panel) is displayed in the second interface 900, while the controls 931-933, the controls 941-944, . . . , and the image slots 951-952 are hidden as shown in FIG. 10. When the image change control 1120 is triggered by a user, it is jumped to the image library to change the second image 910. In some embodiments, a second preset control is displayed in the second interface; in response to a trigger operation on the second preset control, the image processing result is displayed in the first interface; in response to determining that the image processing result is the background image, a third matting operation is performed on the image processing result to obtain a corresponding third matted image; or in response to determining that the layer processing result is the first image, secondary preset function processing is performed on the image processing result to obtain a corresponding secondary processing result.

The second preset control may be used to import an image processing result of the second image into the first interface to load more image processing functions, for example, matting, and stylizing processing. When the image processing result is imported into the background layer, a matting operation may be performed on the image processing result, and the second image 910 may also subjected to preset function processing in the second interface and third matting processing in the first interface, for example, performing erasing and matting processing on the second image 910. When the image processing result is imported into the first layer, preset function processing may be performed again on the image processing result, and the second image 910 may also subjected to preset function processing in the second interface and preset function processing in the first interface, for example, performing erasing processing twice on the second image 910.

In some embodiments, the method 300 further includes: applying, on the second image, a preset template with no background layer, where in response to a trigger operation on the second preset control, the image processing result being displayed in the first interface includes: in response to the size of the image processing result being smaller than that of the second image, adding a corresponding image background layer in the first interface for the image processing result.

Specifically, for a preset template that does not have a background layer, such as a single-image color-palette template, a corresponding layer check box cannot be presented during editing due to the absence of a background layer. It may be maintained that a layer that cannot be clicked for selection in a canvas area does not display a layer check box. Based on this, the function panel controls in the layer selection box, for example, an entry for the erasing function, may also not be presented. In response to a corresponding image slot being selected to display a first preset control, the preset function panel may be entered by triggering this first preset control. Further, when the preset function processing is completed, no background layer may be added, for example, after the erasing processing is applied, the obtained erasing result is hollowed with a visible transparent grid, but the background layer is not automatically added in the editing interface (for example, in the second interface), and the layer still cannot be clicked to be selected, moved or zoomed. After erasing processing is completed, after an image in the editing interface is replaced, the erasing result and canvas size of the old image may not be retained, and the new image may be used to apply the template for complete display. If the erasing function of the second interface is applied to the image layer, a transparent background layer of the same size as the image may be automatically added upon entering the first interface, and the image layer may be selected, moved and zoomed. For example, when the erasing result is fully restored in the editing interface after any one of undo, reset, or the restore pens, no new background layer is added upon entering the first interface. In the editing interface, when the restore pen does not completely restore the erasing result, a new background layer is added upon entering the first interface.

In some embodiments, the performing a third matting operation on the image processing result to obtain a corresponding third matted image includes: normalizing a preset color channel value of a first mask corresponding to the image processing result into a normalized channel value; generating a transparent channel value based on the normalized channel value and the preset channel value; generating a second mask based on the transparent channel value, and applying the second mask to the image processing result to obtain an intermediate image; and performing the third matting operation on the intermediate image to obtain the third matting operation.

Specifically, in order to meet a user's need for secondary editing, the user may perform preset function processing (e.g., erasing processing) on the layer in the editing interface of the template (e.g., the second interface), and may perform secondary editing in the matting function in the first interface. The erasing processing may mean that a user may generate an erasing mask in a painted area, the area where the corresponding layer overlaps with the erasing mask may be erased, and the rest of the layer may be retained. The matting process can mean that the user generates a matting mask for the painted area, and the area where the corresponding layer overlaps with the matting mask is retained and the rest is erased. The effective color channel (RGBA channel) of the matting mask of the matting processing is not the same as that of the erase mask of the erasing processing, the effective channel of the erasing mask is an R channel, and the effective channel of the matting mask is an A channel. The erasing mask (i.e., the first mask) generated in the erasing processing may be normalized for the R channel value, and the difference between the normalized channel value and the preset channel value (e.g., 1) is converted to the transparent channel value, and the matting mask (i.e., the second mask) is generated based on the transparent channel value. The matting mask is added to the corresponding layer to realize the transition from the erasing effect to matting.

It should be noted that the method in the embodiments of the present disclosure may be performed by a single device, such as a computer or a server. The method in the embodiments may also be applied to a distributed scenario to be completed through cooperation of a plurality of devices. In the distributed scenario, one of the plurality of devices may only perform one or more steps of the method in the embodiments of the present disclosure. The plurality of devices interact with each other to complete the method.

It should be noted that some embodiments of the present disclosure are described above. Other embodiments are within the scope of the appended claims. In some cases, the actions or steps recited in the claims can be performed in an order different from that in the above embodiments, and can still achieve desired results. In addition, the processes depicted in the accompanying drawings are not necessarily required to be shown in a particular or sequential order, to achieve desired results. In some implementations, multi-task processing and parallel processing are also possible or may be advantageous.

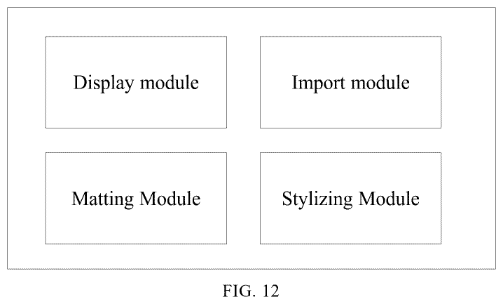

Based on the same technical concept, corresponding to the method in any one of the above embodiments, the present disclosure further provides an image processing apparatus. Referring to FIG. 12, the image processing apparatus includes: a display module, configured to display a background image in a first area of a first interface; an import module, configured to in response to an import operation for an import image, display the import image in the background image; a matting module, configured to in response to a first matting operation for the import image, perform first matting processing on the import image to obtain a first matted image of the import image; and a stylizing module, configured to in response to a first stylizing operation for the first matted image, perform first stylizing processing on the first matted image to obtain a first stylized image; and/or in response to a second stylizing processing operation for at least part of the background image, perform second stylizing processing on the at least part of the background image to obtain a second stylized image.

The display module is further configured to display the first stylized image or the first matted image in the first area, and display the background image or the second stylized image in the first area.

For ease of description, when described, the above apparatus is divided into various modules based on functions. Certainly, functions of the modules may be implemented in one or more pieces of software and/or hardware when the present disclosure is implemented.

The apparatus in the above embodiment is configured to implement the corresponding image processing method in any one of the above embodiments, and has the beneficial effects of the corresponding method embodiment, which are not repeated herein.

Based on the same technical concept, corresponding to the method according to any one of the above embodiments, the present disclosure further provides a non-transitory computer-readable storage medium storing computer instructions. The computer instructions are used to cause the computer to perform the image processing method according to any one of the above embodiments.

The computer-readable medium in this embodiment includes permanent and non-permanent, removable and non-removable media and may implement information storage by using any method or technology. Information may be computer-readable instructions, data structures, modules of a program, or other data. Examples of the computer storage medium include but are not limited to a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, or any other non-transmission media that may be configured to store information capable of being accessed by a computing device.

The computer instructions stored on the storage medium in the above embodiment are used to cause the computer to perform the image processing method in any one of the above embodiments, and have the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the above description. For example, the discussed embodiments may be used for other memory architectures (e.g., a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

I/We claim:

1. An image processing method, comprising:
displaying a background image in a first area of a first interface;
in response to an import operation for a first image, displaying the first image in the background image;
in response to a first matting operation for the first image, performing first matting processing on the first image to obtain a first matted image of the first image;
in response to a first stylizing operation for the first matted image, performing first stylizing processing on the first matted image to obtain a first stylized image; and/or in response to a second stylizing processing operation for at least part of the background image, performing second stylizing processing on the at least part of the background image to obtain a second stylized image; and
displaying the first stylized image or the first matted image in the first area, and displaying the background image or the second stylized image in the first area.

2. The method according to claim 1, wherein in response to the import operation for the first image, displaying the imported first image in the first area comprises:
displaying a first import control in a second area of the first interface;
in response to an import trigger operation on the first import control, jumping to an image library interface to display an image library; and
in response to a selection operation for a candidate image in the image library, displaying the first image in the first area, wherein the first image is obtained based on the selected candidate image.

3. The method according to claim 2, wherein the first image being obtained based on the selected candidate comprises:
in response to a second matting operation for the selected candidate image, performing second matting processing on the selected candidate image to obtain the first image.

4. The method according to claim 1, wherein the background image is displayed in a background layer of the first interface, and the first image and the first matted image are displayed in a first layer of the first interface; and
displaying the first matted image in the background image comprises:
a first layer selection box for the first layer corresponding to the first matted image comprising a minimum bounding rectangle for the first matted image; and/or
a first layer position of the first layer corresponding to the first matted image being located in a centered position of the first image when displayed in the first layer.

5. The method according to claim 1, wherein the first matting operation comprises a preset matting operation regarding a preset object, and the method further comprises:
recording an actual processing order of at least one of the first stylizing processing or the second stylizing processing and the first matting operation to obtain an effect processing order for each layer; and
generating an effect template based on one of the first stylized image or the first matted image and one of the second stylized image or the background image, wherein effect attributes of the effect template comprise: an effect processing order of each layer, a background layer position of the background image, and a layer position of each layer.

6. The method according to claim 5, wherein the second matting operation comprises the preset matting operation; and
recording the actual processing order of at least one of the first stylizing processing or the second stylizing processing and the first matting operation to obtain the effect processing order for each layer further comprises:
recording an actual processing order of the second matting operation, the first matting operation, and the first stylizing processing and/or the second stylizing processing to obtain an effect processing order of each layer, wherein in response to the second matting operation and the first matting operation being consecutive operations, the second matting operation and the first matting operation are merged and recorded.

7. The method according to claim 5, further comprising:
in response to the effect template being invoked, processing the image to be processed based on the effect attributes.

8. The method according to claim 1, further comprising:
displaying a second image in a second interface, wherein the second image is imported into the second interface via an image library;
in response to the second image being selected, displaying a second layer selection box for the second image, wherein a function panel control regarding a preset function is displayed at a preset position of the second layer selection box;
in response to a trigger operation for the function panel control, displaying a preset function panel corresponding to the preset function;
in response to a setting operation of the preset function panel, determining a function operation parameter; and
performing preset function processing on the second image based on the function operation parameter to obtain an image processing result.

9. The method according to claim 8, wherein the second interface further displays an image slot of the second image; and the method further comprises:
in response to a trigger operation for the image slot, displaying the second layer selection box for the second image, and displaying a first preset control in an associated area of the image slot; or in response to the second image being selected, displaying an edit identifier in the image slot corresponding to the second image, and the edit identifier being used for displaying the first preset control in the associated area of the image slot; and
in response to a trigger operation for the first preset control, displaying the preset function panel.

10. The method according to claim 8, further comprising:
displaying a second preset control in the second interface;
in response to a trigger operation on the second preset control, displaying the image processing result in the first interface;
in response to determining that the image processing result is the background image, performing a third matting operation on the image processing result to obtain a corresponding third matted image; or
in response to determining that the layer processing result is the first image, performing secondary preset function processing on the image processing result to obtain a corresponding secondary processing result.

11. The method according to claim 10, further comprising:
applying, on the second image, a preset template with no background layer,
wherein in response to the trigger operation on the second preset control, displaying the image processing result in the first interface comprises:
in response to the image processing result having a size smaller than the second image, adding a corresponding image background layer in the first interface for the image processing result.

12. The method according to claim 10, wherein the performing the third matting operation on the image processing result to obtain the corresponding third matted image comprises:
normalizing a preset color channel value of a first mask corresponding to the image processing result into a normalized channel value;
generating a transparent channel value based on the normalized channel value and a preset channel value;
generating a second mask based on the transparent channel value, and applying the second mask to the image processing result to obtain an intermediate image; and
performing the third matting operation on the intermediate image to obtain the third matted image.

13. An electronic device, comprising a memory, a processor, and a computer program stored on the memory and executable by the processor, and the computer program, when executed by the processor, causing the processor to:
display a background image in a first area of a first interface;
in response to an import operation for a first image, display the first image in the background image;
in response to a first matting operation for the first image, perform first matting processing on the first image to obtain a first matted image of the first image;
in response to a first stylizing operation for the first matted image, perform first stylizing processing on the first matted image to obtain a first stylized image; and/or in response to a second stylizing processing operation for at least part of the background image, perform second stylizing processing on the at least part of the background image to obtain a second stylized image; and
display the first stylized image or the first matted image in the first area, and display the background image or the second stylized image in the first area.

14. The electronic device according to claim 13, wherein the computer program, when executed by the processor, causing the processor to in response to the import operation for the first image, display the imported first image in the first area comprises causing the processor to:
display a first import control in a second area of the first interface;
in response to an import trigger operation on the first import control, jump to an image library interface to display an image library; and
in response to a selection operation for a candidate image in the image library, display the first image in the first area, wherein the first image is obtained based on the selected candidate image.

15. The electronic device according to claim 14, wherein the first image being obtained based on the selected candidate comprises:
in response to a second matting operation for the selected candidate image, performing second matting processing on the selected candidate image to obtain the first image.

16. The electronic device according to claim 13, wherein the background image is displayed in a background layer of the first interface, and the first image and the first matted image are displayed in a first layer of the first interface; and
the computer program, when executed by the processor, causing the processor to display the first matted image in the background image comprises:
a first layer selection box for the first layer corresponding to the first matted image comprising a minimum bounding rectangle for the first matted image; and/or
a first layer position of the first layer corresponding to the first matted image being located in a centered position of the first image when displayed in the first layer.

17. The electronic device according to claim 13, wherein the first matting operation comprises a preset matting operation regarding a preset object, and the computer program, when executed by the processor, further causing the processor to:
record an actual processing order of at least one of the first stylizing processing or the second stylizing processing and the first matting operation to obtain an effect processing order for each layer; and
generate an effect template based on one of the first stylized image or the first matted image and one of the second stylized image or the background image, wherein effect attributes of the effect template comprise: an effect processing order of each layer, a background layer position of the background image, and a layer position of each layer.

18. The electronic device according to claim 7, wherein the second matting operation comprises the preset matting operation; and
the computer program, when executed by the processor, causing the processor to record the actual processing order of at least one of the first stylizing processing or the second stylizing processing and the first matting operation to obtain the effect processing order for each layer further comprises causing the processor to:
record an actual processing order of the second matting operation, the first matting operation, and the first stylizing processing and/or the second stylizing processing to obtain an effect processing order of each layer, wherein in response to the second matting operation and the first matting operation being consecutive operations, the second matting operation and the first matting operation are merged and recorded.

19. The electronic device according to claim 17, the computer program, when executed by the processor, further causing the processor to:
in response to the effect template being invoked, process the image to be processed based on the effect attributes.

20. A non-transitory computer-readable storage medium storing computer instructions, and the computer instructions being used to cause a computer to:
display a background image in a first area of a first interface;
in response to an import operation for a first image, display the first image in the background image;
in response to a first matting operation for the first image, perform first matting processing on the first image to obtain a first matted image of the first image;
in response to a first stylizing operation for the first matted image, perform first stylizing processing on the first matted image to obtain a first stylized image; and/or in response to a second stylizing processing operation for at least part of the background image, perform second stylizing processing on the at least part of the background image to obtain a second stylized image; and
display the first stylized image or the first matted image in the first area, and display the background image or the second stylized image in the first area.
